(19) United States
(12) Patent Application Publication
(10) Pub. No.: US 2018/0331851 A1
(43) Pub. Date: Nov. 15, 2018

(54) DEVICES AND METHODS FOR DATA ACQUISITION IN RETAIL SALE SYSTEMS

(71) Applicant: DataMetrex Limited, Toronto (CA)

(72) Inventor: Jonathan Hobbs, Dunrobin (CA)

(21) Appl. No.: 15/975,235

(22) Filed: May 9, 2018

Related U.S. Application Data
(60) Provisional application No. 62/503,675, filed on May 9, 2017.
(60) Provisional application No. 62/503,742, filed on May 9, 2017.

(51) Int. Cl. H04L 12/40; H04L 29/06; H04L 29/08

(52) U.S. Cl. CPC H04L 12/40013; H04L 69/03; H04L 69/324; H04L 69/14; H04L 69/08

(57) ABSTRACT

A hub tap device, a data tap system, and a method for acquiring retail data are disclosed. The hub tap device collects and transmits data flowing between two apparatus communicating with each other via Universal Serial Bus (USB) communications. The hub tap device includes a first USB upstream port; a second USB downstream port; a communications module; and a processor configured to pass USB communications between the first USB Upstream port and the second USB downstream port; copy the USB communications, extract data from the copied USB communications, and transmit the extracted data to a communications network through the communications module.

### CROSS-REFERENCE TO RELATED APPLICATIONS

This application is related to U.S. provisional patent application No. 62/333,612, filed May 9, 2016, entitled SERIAL COMMUNICATIONS TAP DEVICE, to US provisional patent application No. 62/503,675, filed May 9, 2017, entitled DATA COLLECTION DEVICE FOR UNIVERSAL SERIAL BUS COMMUNICATIONS, and to US patent application No. 62/503,742, filed on May 9, 2017, entitled METHODS FOR DATA ACQUISITION IN RETAIL SALE SYSTEMS, which are incorporated herein by reference.

### FIELD

The present application generally relates to data collection, and specifically relates to devices and methods for data acquisition,

### BACKGROUND

The Internet is a global system of interconnected computers and networks that utilize the Transmission Control Protocol/Internet Protocol (TCP/IP) to communicate. The “Internet of Things” (IOT) is the concept in which a wide variety of physical objects connect to the Internet,

Many legacy devices are not TCP/IP capable and do not have the ability to connect to the internet. A variety of market forces are driving the need to have legacy devices, and the data they contain, become contributing members of the IOT.

As well, retail data activity reports are used by a wide range of industry participants. Manufacturers, wholesalers and distributors use this information for product planning, logistics, marketing and sales activities. Retailers themselves use this information for inventory management, financial projections and planning, and marketing activities.

Current Point-of-Sale (POS) systems used by the retail industry vary widely in their ability to provide activity reports. Many POS systems have no Internet connectivity and can only provide activity reports on a local basis (Le. via the screen or printer of the POS system). Other POS systems have the ability to merge activity reports from multiple POS systems, but only within the confines of a single retailer (e.g. a retailer with multiple stores can combine the activity reports from POS systems within the retailer's stores) and only within the confines of a particular brand or type of POS system.

### SUMMARY

In an aspect, the present invention comprises a Universal Serial Bus (USB) hub tap device that is configured to copy data from USB communications between two, or more, devices and then transmits the copied data to a remote server via a communications network such as the Internet.

Devices connected to the USB hub tap device may be any devices that can communicate with each other via the USB communications protocol. The present invention enables the data flowing between the connected devices to be captured and sent to the remote server without any impact on the data flows between the devices.

In one embodiment, the USB hub tap device comprises: two USB ports, a processor, and a communications module.

In another aspect, the present invention comprises methods and systems that acquire retail data going into the POS system and also retail data produced and sent out by the POS system,

Retail data going into a POS system includes data from data collection devices, such as hand held scanners, flatbed scanners, weigh scales, etc. Data collection devices are connected to POS systems and send the collected data into the POS system, The type of data collected by these devices may include product codes, such as Universal Product Code (UPC), Stock Keeping Unit (SKU), etc, and weights.

Retail data sent out by the POS system is that data sent by the POS to locally connected devices such as screen displays, printers, receipt printers, etc. This type of retail data includes unit and total prices, quantities, weights, product descriptions, etc.

Data is acquired from “before” the POS system and “after” the POS system and then sent to a remote server, via the Internet, where it is combined to provide high quality, aggregated retail data containing information about products purchased, time of purchase, the number and/or combination of products purchased in a transaction, price, weight, payment method, geographic store location, POS identification within a store, since a retailer may have multiple checkout lanes.

According to an aspect, there is provided a hub tap device collects and transmits data flowing between two apparatus communicating with each other via Universal Serial Bus (USB) communications. The hub tap device includes a first USB upstream port; a second USB downstream port; a communications module; and a processor configured to pass USB communications between the first USB upstream port and the second USB downstream port; copy the USB communications, extract data from the copied USB communications, and transmit the extracted data to a communications network through the communications module.

According to another aspect, there is provided a data tap system which comprises a first data tap device connected between a data collection device and a Point of Sale (POS) system for capturing a first data flow between the data collection device and the POS system; a second data tap device connected between the POS system and a data output device for capturing a second data flow between the POS system and the data output device; and a controller connected with the first and second data tap devices for processing the first and second data flows.

According to another aspect, there is provided a method for acquiring retail data, comprising: capturing, by a first data tap device, a first data flow between at least one data collection device and at least one POS system; capturing, a second data tap device, a second data flow between the at least one POS system and at least one data output device; transmitting, by a controller, the first data flow and the second data flow to a remote server; and processing, by the remote server, the received first data flow and second data flow.

The methods disclosed herewith allow retail activity to be tracked in real time, across multiple stores or vendors, and without requiring advance information (and continuous updates) about the UPC code and product associations for a vast number of manufacturers

As well, the methods and systems described herein enable an accurate correlation and tracking of this retail data by bridging the disconnect between information used by manufacturers, distributors and retailers

The retail data collected according to the method disclosed herewith is high quality because: (i) it combines product UPC or SKU codes with at least one of prices, descriptions, quantities, and weights, etc.; (ii) data is collected in real-time; and (iii) data from multiple POS systems can be easily aggregated on the remote server, automatically analyzed and quickly reported.

### BRIEF DESCRIPTION OF THE DRAWINGS

Reference will now be made, by way of example, to the accompanying drawings which show example embodiments of the present application, and in which:

FIG. 1 is a block diagram illustrating a system according to an embodiment of the present application;

FIG. 2 is a block diagram illustrating a USB hub tap device of FIG. 1, according to one embodiment;

FIG. 3 is a block diagram illustrating a second embodiment of the hub tap device of FIG. 1;

FIG. 4 shows examples of USB transactions and associated packets;

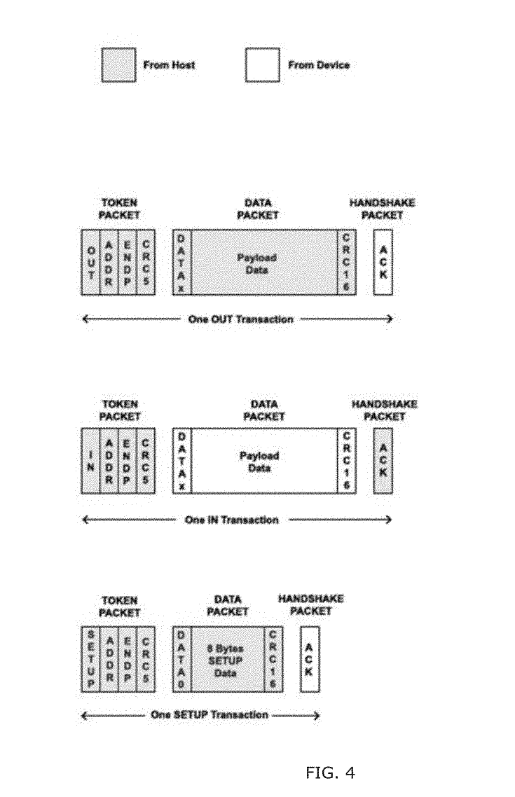

FIG. 5 is a block diagram illustrating a retail Point-of-Sale (POS) environment;

FIG. 6 is a block diagram illustrating data acquisition in the retail POS system according to an embodiment of the present disclosure; and

FIG. 7 is a block diagram illustrating data acquisition in the retail POS environment according to another embodiment of the present disclosure.

Similar reference numerals may have been used in different figures to denote similar components.

### DESCRIPTION OF EXAMPLE EMBODIMENTS

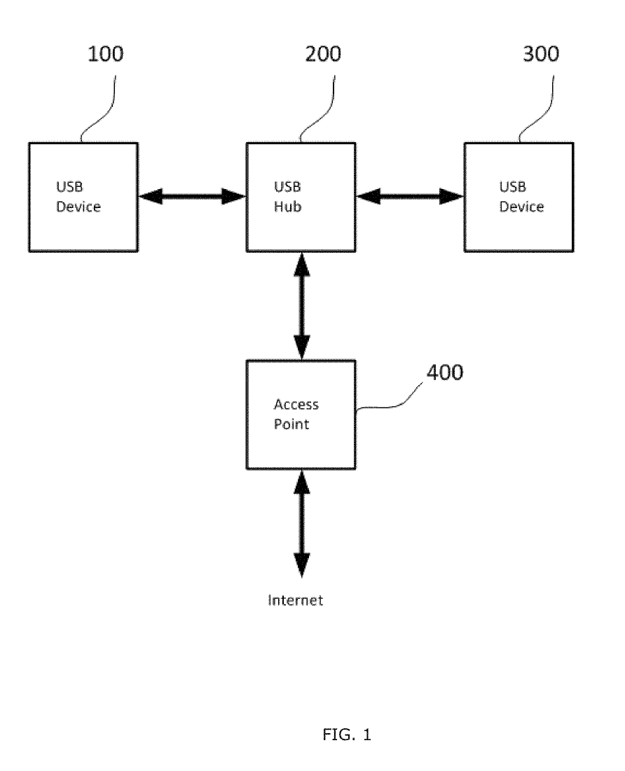

As depicted in FIG. 1, in a system 2 according to an example of the present disclosure, there is provided a hub tap device 200 which may be a Universal Serial Bus (USB) hub device and which is connected in-between two data collection devices 100, 300, which may be USB devices, in order to capture data exchanged in communication flows between the devices 100, 300. The hub tap device 200 may copy and then extract the data contained within the communication flows and forward the extracted data, via wired or wireless communications to an access point 400. The access point 400 may then forward the extracted data through a communications network, such as the Internet, to a remote server or other apparatus connected to the communications network.

In one embodiment, the components of the hub tap device 200 may comprise: a upstream USB port 201A and a downstream USB port 201B; electrical connections 202 for power, ground, and differential data signals (D+, D−) between the two USB ports 201A, 201B and the processor 203. In some examples, the tap device 200 may include a communications module 204 for the tap device 200 to communicate with other devices, such as a remote server or an access point. In some examples, the tap device 200 may also include one or more memories 205 for storing data received or processed by the tap device 200. For clarity, other components such as resistors, capacitors, diodes, etc. are not shown. Further embodiments may include a upstream USS port 201A and multiple downstream USB ports 2018. In some embodiments, the hub tap device 200 may include one or more additional internal or external power source (not shown) so that the power provided by the upstream USB port 201A is fully provided to the downstream USB port(s) 201B.

USB devices 100, 300 can be any type of electronic equipment that can be connected and communicate via the USB communications protocol. Examples of USB devices include: computers, printers, displays, cameras, phones, retail point-of-sale (POS) devices, scanners, weight scales, etc. It will be appreciated that the connection at one or both of the USB devices 100, 300 may be an independent USB port, or a USB port provided through a traditional USB hub housed within the USB devices 100, 300.

Processor 203 may be connected, directly, or indirectly, for example through electronic components such as resistors, capacitors, diodes, etc., to other electrical connections. Processor 203 may perform some functions similar to a traditional USB hub and allows USB devices 100 and 300 to connect and communicate with each other. In some examples, the processor 203 repeats or forwards signals received from the upstream port 201A to the downstream port 201B. Similarly, signals received from the downstream port 201E are repeated or forwarded to the upstream port 201A. For these standard functions, the processor 203 and hub tap device 200 may operate in accordance with the USB Specification Revision 2.0.

Unlike a traditional USB hub, however, the processor 203 may also scan the USB transaction packets and copies the USB frames or USB data packets in order to extract data from the communications between the USB devices 100, 300.

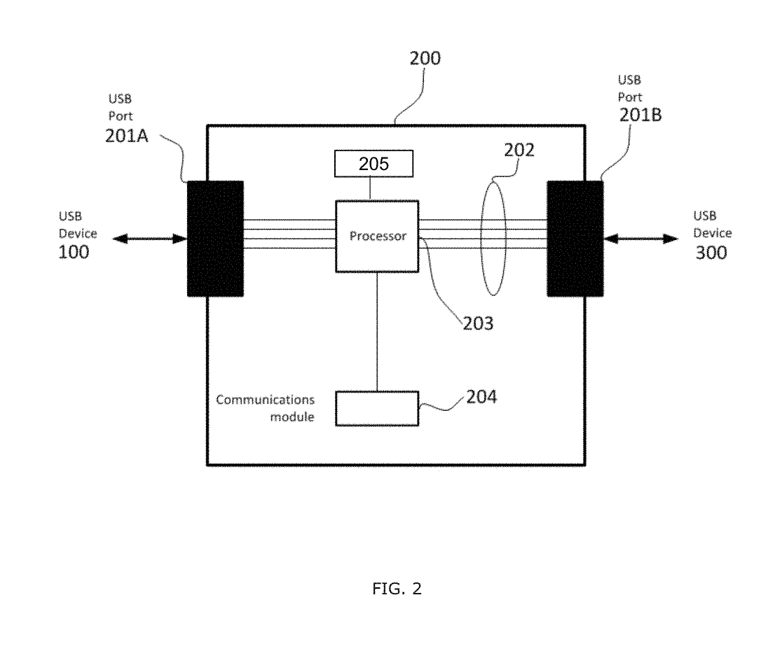

In one embodiment, the processor 203 may extract data from the USB communications flow between USB devices 100, 300, for example using the following method:
1. The processor 203 may monitor the USB communications flows between the devices 100, 300 in order to detect target transaction types. The target transaction types may include USB Interrupt, Bulk and Isochronous transaction types, Control transaction types do not contain data related to the communications or exchange of information between the USB devices 100, 300 and therefore, the processor 203 may not check for these types of transactions. USB transaction types are typically implemented using USB endpoints which are unidirectional pipes that carry data between connected devices. The processor 203 thus may monitor the communications to and from corresponding USB endpoints.
2. The processor 203 may copy USB frames and microframes containing the target transaction types and then extract the USB data packets from the copied USB frames or microframes. For example, USB data packets may be identified using “DATA0” (PID 0011b), “DATA1” (PID 1011b), “DATA2” (PID 0111b) and “MDATA” (PID 1111b) USB packet identifiers. Packets of Control transaction types, such as “Token”, “Handshake”, and special identifiers (e.g. SOF—start of frame), may be ignored as they do not carry data that is to be copied.
3. The processor 203 may perform an additional action to extract raw data, i.e. the payload information from the USB data packets and then repackage the extracted raw data into a single hub data package. Because a single USB transaction can comprise many USB frames and USB packets, raw data may be extracted from all USB data packets that make up a single USB transaction and then combined into a single hub data package.
4. The processor 203 may forward the hub data package to the communications module 204 in FIG. 2 for transmission.

In some embodiments, the processor 203 may copy entire USB frames and/or entire USB packets of interest and transmit the copied USB frames and/or entire USB packets to a remote server for further processing. It Will be appreciated, however, that by configuring the processor 203 to capture and repackage only the information or data of interest, the amount of information transmitted over the communications network is reduced.

Optionally, the processor 203 may execute software stored in a memory 205 and operate to filter the extracted raw data, according to a pre-determined filtering algorithm. The processor 203 creates the hub data package using only extracted raw data which meets the filtering criteria and forwards the hub data package to the communications module 204 for transmission.

For example, filters may be implemented that exclude certain data, or only include certain data. In one example embodiment, the processor 203 and hub tap device 200 are configured to filter and capture specific information, such as data communications between two devices 100, 300 in a retail sales environment. Such targeted communications may contain, for example, a Universal Product Code (UPC) consisting of 12 numeric digits. Because the first 5 digits of the UPC are specific to a manufacturer, these digits could be used to filter and capture only data and communications related to products for a specific manufacturer. In some configurations, pricing data could be captured by a processor 203 configured to filter or capture information that corresponds to a dollar sign followed by a floating point number with 2 decimal places of precision. In other configurations, specific product names could be filtered and captured (e.g. a product name, description or trademark such as “coke”). The filtered and captured information may be used by other parties, such as manufacturers, wholesalers and distributors, in the manners to be described in greater detail below.

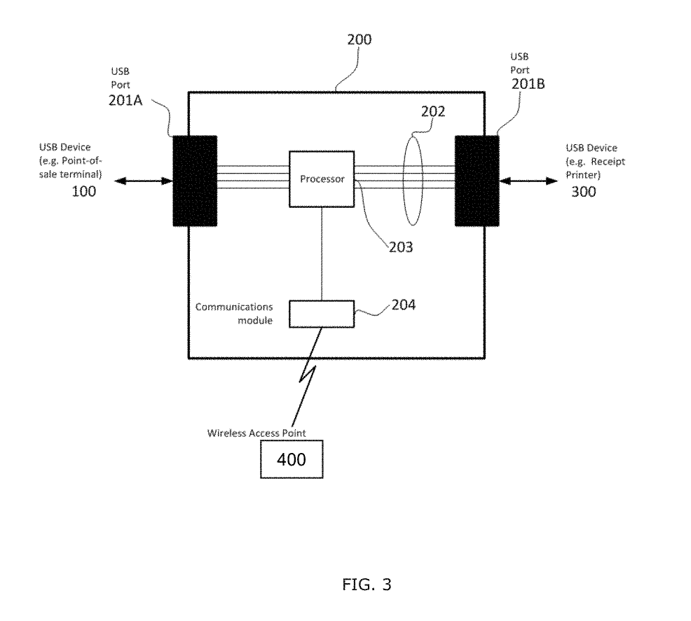

The communications module 204 may receive the hub data package from the processor 203 and may transmit the hub data package to an access point 400 (FIG. 3). While shown separately in FIG. 2, it will be appreciated that in some embodiments, a single module may perform the functions of the processor 203 and the communications module 204. The single module may consist of a single integrated circuit (IC), one or more integrated circuits, or a processor and related electronic circuitry, memory and software.

The access point 400 may be, for example, a router, switch, or WiFi™ access point that communicates with a communications network such as the Internet. In one embodiment, wireless communications is achieved using WiFi™ technology. In alternative embodiments, the communications module 204 may be configured to transmit data packets according to any form of wireless transmission, including but not limited to: wireless local area network communications such as WiFi™; short range wireless communications such as Bluetooth™, or Zigbee™; or cellular communications such as code-division multiple access (CDMA); time-division multiple access (TDMA); Global System for Mobile Communications (GSM™); Universal Mobile Telecommunications System (UMTS); Long-Term Evolution (LTE™); General Packet Radio Service (GPRS); Evolution-Data Optimized (EVDO); Enhanced Data rates for GSM Evolution (EDGE); or Integrated Digital Enhanced Network (iDEN).

Access point 400 may then forward the data packets, received from communications module 204, to a server, computer or other device (not shown) which is connected to the communications network. Once the data is available via the Internet, a variety of end-uses can be supported such as, but not limited to: data analytics, real-time feedback based on business logic, and/or data aggregation. New business models, based on IOT, are made possible as a result of the data collected by the hub tap device 200 described herein.

One example of an implementation of the present invention is illustrated in FIG. 3, which depicts a USB device 100, such as retail point-of-sale (POS) terminal, for example a cash register, connected via USB communications with a second USB device 300, such as a receipt printer. The hub tap device 200 of the present application is connected, in-between the first and second USB devices 100, 300, such as between the cash register and the printer. All data sent from the cash register to the printer, such as product Stock Keeping Units (SKUs), prices, quantities, weights, coupons, product descriptions, discounts, or refunds, are captured by the hub tap device 200 as described herein and transmitted, via the communications module 204, wiredly or wirelessly, to a remote server connected to the Internet.

Another example of an implementation of the present invention may be a scanner connected to a cash register. A hub tap device 200 of the present application may be connected, in-between the first and second USB devices 100, 300, such as the cash register and the scanner. All scanned data, such as product SKUs and coupons, may be captured by the hub tap device 200 and forwarded to a remote server connected to the Internet via the communications module 204.

While current point of sale (POS) data collection methods and reports may meet the needs of the retailer, manufacturers, wholesalers and distributors need to capture and aggregate data regarding the products they sell and/or distribute from across multiple retailers.

Current methods may include data aggregators acquiring data from multiple retailers, typically on a monthly basis, and then manually combining the data reports from each retailer into a single aggregated report. This is an expensive and manually intensive process and provides data which can be months out of date by the time it is collected, assembled, analyzed and finally reported. The acquisition and compilation of retail data in real time enables, for example, a marketing organization to evaluate the effectiveness of a promotional campaign as it occurs. As a further example, merchants or marketers may provide instant feedback or additional marketing messages to a purchaser such as through in-store signage which may be controlled to display a promotion for a product related to an item just purchased. Wholesalers and/or distributors also may use the information acquired in real-time in order to quickly react to spikes in purchases across one or more retail stores in order deliver additional products or reallocate products to retail stores.

The hub tap device 200 described above may be used to enable real-time data collection from multiple retailers, and automatically combines the data Into a single, easy to access database of retail activity which meets the needs of other parties, such as manufacturers, wholesalers and distributors.

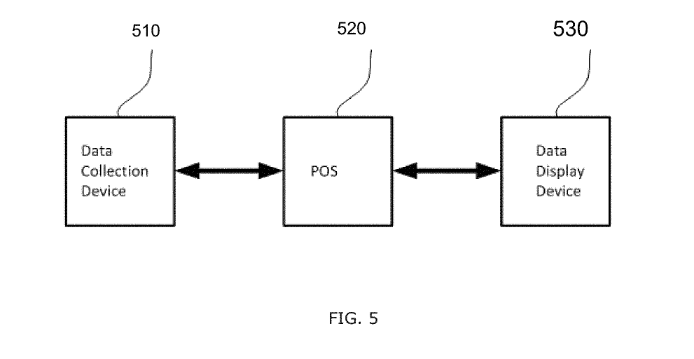

In the example illustrated in FIG. 5, data flows from the data collection device 510 to the point of sale (POS) system 520. The Data Collection Device 510 may be a scanner, weigh scale or other device through which information is collected or input into the POS system 520. Input data, such as UPC or SKU codes or weights of a product or products being purchased, is sent from the Data Collection Device 510 to the POS system 520. The POS system 520 may be a cash register, payment terminal, or other computer terminal configured to process a transaction for the purchase of a product or products.

The POS system 520 may send data collected form the data collection device 510 to the Data Output Device 530, such as a data display device. The Data Output Device 330 may he a screen display, a receipt printer or other device which sends out data from the POS system 520 about the product or products being purchased. Output data, such as unit price or total prices, product descriptions, quantities, weights, etc. may be sent from the POS system 520 to the Data Output Device 530.

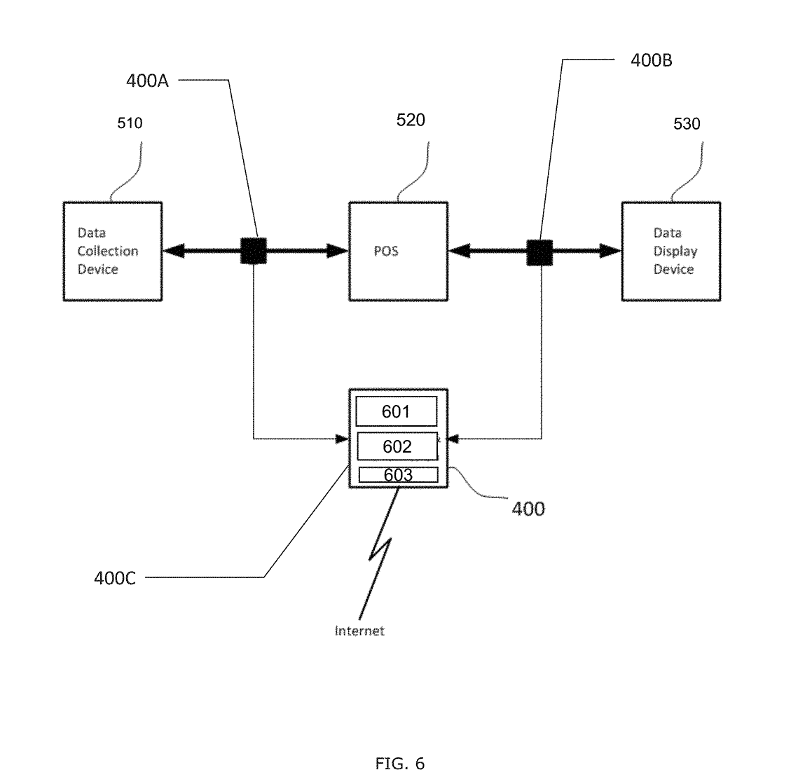

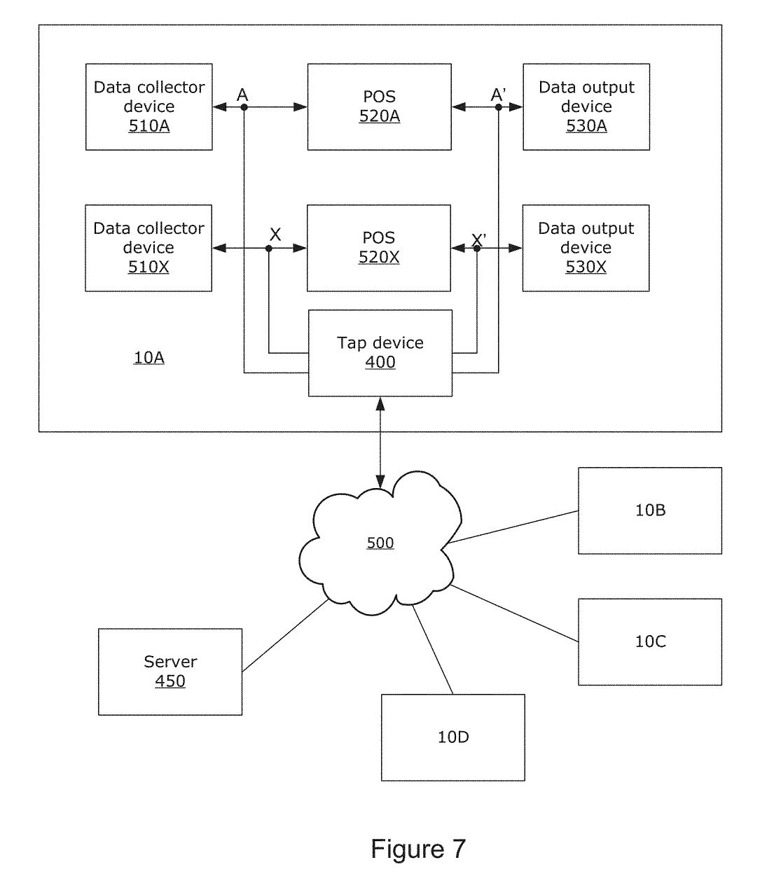

As depicted in FIG. 6, to acquire and transmit the data sent between the data collection device 510 and the POS system 520, a data tap device or system 400 is connected to capture data flows into and out of the POS system 520. In one embodiment, the data tap device or system 400 includes tap devices 400A, 400B and a controller 400C. The first data tap device or system 400A is connected in-between the data collection device 510 and the POS system 520 to capture the data flow between the data collection device 510 and the POS system 520. Similarly, the second data tap device 400B is connected in-between the POS system 520 and the data output device 530 to capture the data flow between the POS system 520 and the data output device 530. Data tap devices 400A and 400B may be the hub tap device 200 described above, or the serial tap device disclosed in the US patent publication No. 2017/0324606, which is incorporated herein by reference. Data tap devices 400A, 40013 may be connected through wired or wireless communications to the controller 400C. The controller 400C processes data captured by the tap devices 400A, 400B and communicates with a remote controller 450 (FIG. 7), for example transmiting the captured data or processed data to the remote server 450 to be described further below. In some examples, the data tap system 400 may include the remote server 450.

In some examples, the controller 400C may include a processor 601 for processing the data captured by the tap devices 400A, 400B, a memory 602 for storing the data captured by the tap devices 400A, 400B or the data processed by the processor 601 or storing instructions or methods to be executed by the processor 601, and a communications module 603 for transmitting the captured data or processed data, for example to the remote server 450. The memory 602 and the communications module 603 are electrically connected with the processor 601. The controller 400C may execute the methods described herein.

FIG. 7 illustrates a second embodiment of the data tap device or system 400. In some examples, the data tap device or system 400 may include multiple ports for connecting to the POS system 520, data collection device 510 and data output device 530 as described above. For example, each of the data tap devices 400A and 400B may include multiple USB ports for connecting to multiple POS systems 520, data collection devices 510 and data output devices 530. In some examples, a data tap device or system 400 may include multiple data tap devices 400A and 400B, rather than one data tap device 400A and one data tap device 400B, for connecting to multiple POS systems 520, data collection devices 510 and data output devices 530 in the similar manners described above.

As also illustrated in FIG. 7, data tap devices or systems 400 can be installed in multiple locations within a single retail store 10A. For example, a single store 10A may have multiple POS systems 520A through 520X, multiple data collection devices 510A through 510X, and multiple data output devices 530A through 530X. The data tap device 400 is connected in-between each of the Data Collection Devices 510 A-X and the POS systems 520 A-X to capture the data flow between the data collection devices 510A-X and the POS systems 520A-X, and connected in-between the POS systems 520A-X and the Data Output Devices 530A-X to capture the data flow between the POS systems 520A-X and the Data Output Devices 530A-X. The connection points A-X, and A′-X′ may be multiple USB ports of the data tap devices 400A and 400B, or multiple data tap devices 400A and 400B. Data tap devices 400 can also be installed in multiple retail stores, 10B, 10C, 10D. The multiple retail stores 10A, 10B, 10C, 10D may be operated by different companies and may use different types of POS systems 520.

Each data tap device 400, such as by using the data tap devices 400A and 400B, may capture payload data or information of interest in the communications between the data collector device 510 and the POS system 520 and forward the captured data to a remote server 450 via a communications network 500 such as the Internet. Each tap device 400 may also capture payload data or information of interest in the communications between the POS system 520 and the data output device 530 and forward the captured data to the remote server 450 via the communications network 500. Since data captured before and after the POS system 520 may occur at different times and may relate to different purchases or transactions, the data tap device 400, for example the possessor 601, may create and forward separate messages for each data capture. In some examples, the possessor 601 of the data tap device 400 may capture and forward the captured payload data or information in the same manner as the tap device 200 described above.

According to another embodiment, before transmitting a message with captured data, each data tap device 400, such as the possessor 601, may add a unique identifier to the captured data it sends to the remote server 450. The unique identifier which allows the remote server 450 to know which store and POS system the data was acquired from. In one embodiment, for example, the unique identifier encodes or consists of information to identify a particular retailer or company, a particular retail location, and a particular POS system 520 within the retail location. The unique identifier also indicates which “side” of the POS system the data was captured from. Thus, for the data tap device 400 shown in FIG. 7, four different unique identifiers would be used to identify data captured from before and after POS system 520A and POS system 520X.

In some embodiments, the remote server 450 may add a timestamp to the captured data when the message is received from the data tap device 400. Alternatively, the data tap device 400, such as the processor 601, may add a timestamp to the captured data when the data is captured by the data tap device 400A and 400B or the message is to be sent out from the communications modules 603. The timestamp and location information from the unique identifier are important data metrics required by manufacturers, distributors and wholesalers as this information enables, for example, analysis of the captured data by region for the purposes of distributing new stock. Time of day information may be used by a retailer to determine staffing levels at a particular location. By way of further example, time of day information and location as determined from the unique identifier may be used for the development of promotional programs. If it is determined that sales of a particular type or brand of soft drink are high in a particular region at a particular period of time, e.g. between 11 am to 1 pm, a retailer or marketer may implement a special offer for the purchase of the particular soft drink and a snack such as potato chips, in order to upsell potential buyers.

The remote server 450 may compile and/or further process the received data. In some examples, the remote server 450 may combine the data received from all installed data tap devices 400 into a database from which data analytics, reports, etc. can be produced for manufacturers, wholesalers and distributors.

In some embodiments, the remoter server 450 may include one or more databases (not shown). The remote server 450 populates, for example, a database of Universal Product Code (UPC) information based on data captured from communications between scanning devices 510 and POS systems 520 at multiple retail locations. Similarly, the remote server 450 may populate a database of product descriptions based on data captured from communications between POS systems 520 and receipt printers 530 at multiple retail locations.

In one embodiment, the remote server 450 is configured to generate correlation values for the UPC codes and product descriptions gathered from the multiple tap device 400 data captures. High probability matched data may be identified if, for example, a sales transaction consists of a single product purchase, the UPC code from the scanner has a high correlation value with the product description and pricing information captured from the printed receipt. These correlations are made by the server 450 based on the unique identifiers and time stamps associated with the received data as well as the information in the captured data. The remote server 450 implements adaptive, linear regression algorithms that combine the above items to produce a resultant dataset of UPC codes or product descriptions with high correlation values. As the remote server 450 acquires more captured data, the adaptive algorithms continually improve the correlation values between UPC codes and product descriptions, thus constantly improving data quality and adding new UPC code and product description information as these are introduced by retailers.

The remote server 450 may link UPC codes with product descriptions, for example, in order to enable the tracking of purchases and retail activities for a particular brand of product, type of product, and/or manufacturer. While each manufacturer may have its own database or known association between UPC codes and products, using the methods described herein allows retail activity to be tracked in real time, across multiple stores or vendors, and without requiring advance information (and continuous updates) about the UPC code and product associations for a vast number of manufacturers. Further, since each retailer and/or different POS systems 520 may use their own non-standard descriptors of a product, the information displayed to a consumer at the point of sale or printed on a receipt by the data output device 530, may vary even for the sale of the same product at multiple retail locations. For example, the same soft drink may be described by the retailer or POS system as Coke™, Coke 350 ml, Coke Plastic Bottle, Coke Disposable Bottle, Coke $1.99, Coke 99 c etc. Such descriptions may change as the retailer varies its product mix as for example, Coke becomes Coke350 mL and Coke1 L after different product sizes are carried by the retailer. Since the display of a scanned product or receipt for a purchase typically does not include the UPC code, the methods and systems described herein enable an accurate correlation and tracking of this retail data by bridging the disconnect between information used by manufacturers, distributors and retailers.

The databases and correlated data generated by the remote server 450 may be used to enable the generation of reports for sales of specific products within any geographic region. Alternatively, competitive analysis may be performed to compare sales volumes and prices for a particular product sold by multiple retailers. In other applications, an advertising company may implement a regional sales promotion and then receive the sales results, in real-time, for the targeted region based on the captured data. The data captured and the datasets generated by the remote server 450 enable a real-time comparison to be made between retail activity in the targeted region and retail activity in regions outside the promotional area. Based on the real-time comparison, the advertising company and/or manufacturer may react promptly to support or address any issues created by the campaign. For example, if a marketing campaign is wildly successful (e.g. greatly exceeded the expectations of the marketing organization) and more product is being sold than was estimated such that product could run out, the marketing organization could halt the marketing campaign proactively such as by stopping radio, television or other advertisements. Comparisons also may be made against historical data for that region. Again, this information may be tracked in real-time across multiple retailers to assist with supply management rather than compiling information from various retailers manually after a product supply has run out.

While the above described embodiments are directed to new systems and methods to acquire data of interest for distributors and wholesalers, it will be appreciated that any interested party may access the acquired data. Retailers, for example, may be interested in accessing their own data from the methods and system described herein in order to gain access to consolidated retail activity data that their own POS installations May not be able to provide.

Certain adaptations and modifications of the described embodiments can be made. Therefore, the above discussed embodiments are considered to be illustrative and not restrictive.

1. A hub tap device to collect and transmit data flowing between two apparatus communicating with each other via Universal Serial Bus (USB) communications, the hub tap device comprising
a first USB upstream port;
a second USB downstream port;
a communications module; and
a processor configured to
pass USB communications between the first USB upstream port and the second USB downstream port;
copy the USB communications,
extract data from the copied USB communications, and
transmit the extracted data to a communications network through the communications module.

2. The hub tap device of claim 1 further comprising multiple downstream ports.

3. The hub tap device of claim 1 wherein the communications module supports wired communications, wireless communications, or a combination thereof.

4. The hub tap device of claim 3 wherein the wireless communications are any one of WiFi, Bluetooth, Zigbee, CDMA, TDMA, GSM, UMTS, LTE, GPRS, EVDO, EDGE, or iDEN communications.

5. The hub tap device of claim 1 wherein the processor is further configured to:
detect one or more USB transaction types in the USB communications,
copy only USB frames containing one or more specific USB transaction types.

6. The hub tap device of claim 5 wherein the USB transaction types consist of a USB Interrupt, a Bulk, or an Isochronous transaction type.

7. The hub tap device of claim 1 wherein the processor is further configured to
create a hub data package incorporating extracted data from multiple USB data frames for a single USB transaction, and
transmit the extracted data in the hub data package.

8. The hub tap device of claim 1 wherein the processor is further configured to filter data from the USB communications according to one or more filter criteria and extract only data meeting the filter criteria.

9. The hub tap device of claim 6 wherein the filter criteria comprises a Universal Product Code (UPC), a portion of a UPC, a product name, or a combination thereof.

10. A data tap system comprising:
a first data tap device connected between a data collection device and a Point of Sale (POS) system for capturing a first data flow between the data collection device and the POS system;
a second data tap device connected between the POS system and a data output device for capturing a second data flow between the POS system and the data output device; and
a controller connected with the first and second data tap devices for processing the first and second data flows.

11. The data tap system of claim 10, wherein each of the first and second data tap device is a hub tap device comprising:
a first USB upstream port;
a second USB downstream port;
a communications module; and
a processor configured to
pass USB communications between the first USB upstream port and the second USB downstream port;
copy the USB communications,
extract data from the copied USB communications, and
transmit the extracted data to a communications network through the communications module.

12. The data tap system of claim 10, wherein the controller comprises:
a processor for processing the first and second data flows;
a memory for storing the first and second data flows or data processed by the processor; and
a communications module for transmitting the first and second data flows or the processed data to a remote server.

13. The data tap system of claim 10, wherein the each of the first and second data tap devices includes multiple USB ports for connecting to multiple POS systems, data collection devices and data output devices.

14. The data tap system of claim 10, wherein each of the first and second data tap devices capture payload data or information of interest in the communications between the data collector device and the POS system.

15. The data tap system of claim 10, further comprising a remote server for communicating with the controller.

16. A method for acquiring retail data, comprising:
capturing, by a first data tap device, a first data flow between at least one data collection device and at least one POS system;
capturing, by a second data tap device, a second data flow between the at least one POS system and at least one data output device;
transmitting, by a controller, the first data flow and the second data flow to a remote server; and
processing, by the remote server, the received first data flow and second data flow.

17. The method of claim 16, wherein the first data flow is captured between multiple data collection devices and multiple POS systems.

18. The method of claim 16, wherein the second data flow is captured between multiple POS systems and multiple data output devices.

19. The method of any one of claim 16, further comprising:
prior to transmitting the first and second data flows, adding a timestamp to each of the first and second data flows when the first and second data flows are captured.

20. The method of any one of claims 16, further comprising: prior to transmitting the first and second data flows, adding a unique identifier to each of the first and second data flows to indicate sources of the first and second data flows.
